(19) United States
(12) Patent Application Publication
(10) Pub. No.: US 2010/0211876 A1
(43) Pub. Date: Aug. 19, 2010

(54) System and Method for Casting Call

(76) Inventor: Dennis Fountaine, Sarasota, FL (US)

Correspondence Address: CARR & FERRELL LLP, 2200 GENG ROAD, PALO ALTO, CA, 94303, US

(21) Appl. No.: 12/562,976

(22) Filed: Sep. 18, 2009

Related U.S. Application Data
(60) Provisional application No. 61/192,642, filed on Sep. 18, 2008.
(60) Provisional application No. 61/192,542, filed on Sep. 18, 2008.
(60) Provisional application No. 61/192,674, filed on Sep. 18, 2008.

(51) Int. Cl. G06F 3/00; G06F 17/30

(52) U.S. Cl. 715/723; 707/769; 707/770; 707/E17.014; 707/E17.028

(57) ABSTRACT

Systems and methods for casting calls are provided. A casting call is generated based on information provided by an individual (e.g., a casting call manager). The casting call may indicate a particular video clip and designates a recipient for submissions related to the casting call. A user interested in participating in the casting call may submit a query. In response to the query, the user is provided with access to the video clip for modification. Such a modification may involve incorporating a recording of a performance into the video clip. As a result, the modified video clip may be generated whereby the user becomes the “actor” in the modified video clip. The modified video clip may be evaluated for compliance with any parameters set by the creator of the casting call and then submitted to the designated recipient.

### CROSS-REFERENCE TO RELATED APPLICATIONS

The present application claims the priority benefit of U.S. provisional patent application number 61/192,642 filed Sep. 18, 2008 and entitled “Interactive Entertainment System,” U.S. provisional patent application number 61/192,542 filed Sep. 18, 2008 and entitled “System and Method for Pre-Engineering Video Clips,” and U.S. provisional patent application 61/192,674 filed Sep. 18, 2008 and titled “System and Method for Social Casting Call,” the disclosures of the aforementioned applications being incorporated herein by reference.

### BACKGROUND OF THE INVENTION

1. Field of the Invention

The present invention generally relates to casting calls. More specifically, the present invention concerns casting calls using video clips modified to incorporate user performance.

2. Description of Related Art

Presently, video clips can originate from movies, television shows, radio shows, music videos, cartoons, video games, advertisements, commercials, news shows, or other sources. In addition to full-length television programs and movies made freely available on-line by well-established television networks and media sources, Internet users can also access, view, upload, share, and/or critique millions of video clips, including amateur video clips made available on websites such as YouTube or iPlayer.

Video and audio are media that allow individuals to showcase their performances for various audiences. Such performances may include singing, dancing, acting, orating, debating, animation, etc. Showcasing one's performance is particularly important in the fields of musical, theatrical, and cinematic arts. Singers, dancers, and actors of all types need to be able to demonstrate their singing, dancing, or acting abilities in order to obtain employment in their chosen fields. Such a demonstration may occur in the context of an audition or audio-video recordings of a past performance.

In a casting call, for example, a casting director or associate generally manages a process to select one or more actors or other entertainment performers to fulfill one or more roles in a live or recorded performance. The casting process is typically performed live and can be burdensome, time-consuming and stressful for all parties involved. Such live auditions may be restricted in terms of geography, timing, scheduling, etc. For example, an audition may be held in an inconvenient location, at an inconvenient time, and/or may not allow much time for a full performance. Further, an audition may lack the context of an actual performance (e.g., band, orchestra, costuming, lighting, sets, other performers).

While an audio-video recording may provide such context, some individuals may not have the resources or the opportunity to prepare such a recording or the opportunity. There is therefore, a need for improved systems and methods for casting calls.

### SUMMARY OF THE INVENTION

Embodiments of the present invention provide for methods and systems for casting calls.

Methods for casting calls may include.

Some embodiments of the present include systems casting calls

Embodiments further provide for computer-readable storage media having embodied thereon programs for performing methods for casting calls.

### BRIEF DESCRIPTION OF THE DRAWINGS

FIG. 1 is a diagram of an environment in which embodiments of the present invention may be practiced.

FIG. 2 illustrates an exemplary server used in casting calls, according to embodiments of the present invention.

FIG. 3 is a flowchart of an exemplary method for casting calls.

### DETAILED DESCRIPTION

Embodiments of the present invention provide systems and methods for providing casting calls. In exemplary embodiments, an individual may submit a video clip selection for use in a casting call. The video clip may comprise, for example, a scene from a movie, television show, music video, cartoon, video game, or commercial. Other types of video clips may be utilized as well. A user interested in participating in the casting call may submit a query. In response to the query, the user is provided with access to the video clip for modification. Such a modification may involve incorporating a recording of a performance into the video clip. As a result, the modified video clip may be generated whereby the user becomes the “actor” in the modified video clip. In some embodiments, the casting call may be submitted by a user in order to find others to participate in generating a modified video clip incorporating multiple performances. As such, multiple recording may be incorporated into the video clip.

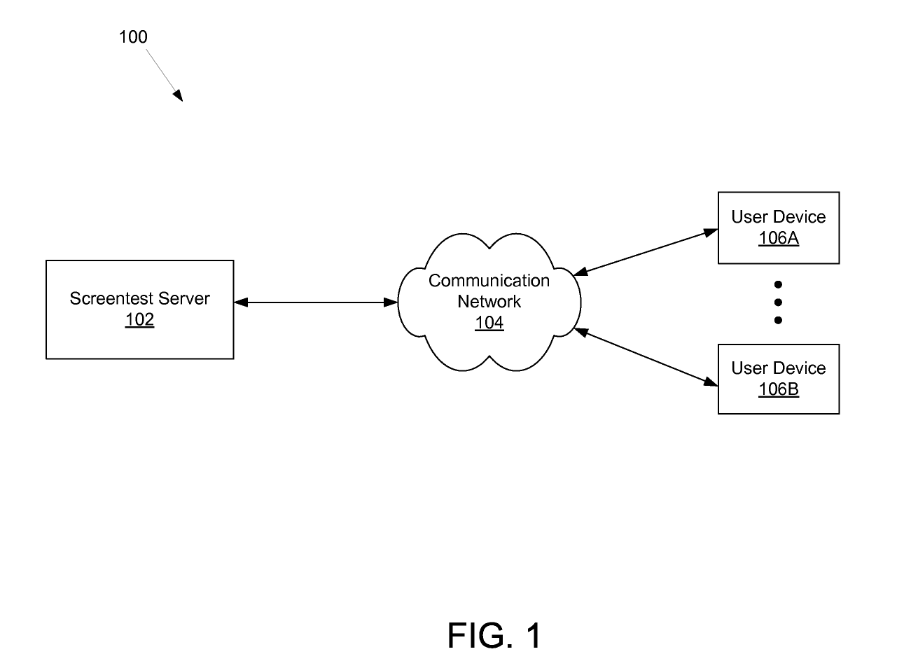

FIG. 1 illustrates an exemplary environment 100 in which embodiments of the present invention may be implemented. In exemplary embodiments, a server 102 is coupled via communication network 104 to a plurality of user devices 106A-106B. The communication network 104 may comprise the Internet, wide area network, and/or a local area network. Certain security protocols (e.g. SSL or VPN) or encryption methodologies may be used to ensure security of data exchanges over communication network 104.

In exemplary embodiments, the server 102 is configured to provide video clips for use in generating and managing casting calls. Such a casting call may indicate a video clip for use in the casting call. A casting call using modified video clips may be created by a user for various purposes, including real-life and/or professional casting calls, socializing, or entertainment purposes. A casting manager, for example, may use modified video clips as part of a round of auditions. Alternatively, a user may simply wish to generate modified video clips for his or her own entertainment.

A casting call may be created by such an individual using the resources and tools provided by server 102. To generate the casting call, the individual may provide (or select from a menu) a video clip, any parameters for a video clip submission, and contact information where the video clip is to be submitted. Such information may be stored on server 102 and may, further, be referenced for a post on a website associated with server 102. The individual creating the casting call may also indicate further information for display with respect to a casting call, including information regarding the type of performer desired, details regarding the project, etc.

A user who wishes to participate in the casting call may query for and receive access to the video clip to create a modified version that incorporates a recording of a performance. The modified clip allows for the user performance to appear in context of the selected video clip, such that the user appears to replace a performer in the video clip. The modified clip may submitted to a designated recipient (i.e., associated with the casting call) and, further, reviewed for compliance with a parameter of the casting call. The user may be notified as to whether the modified video clip meets the parameter or not. As such, the user may submit a new modified clip. Server 102 may be any computing device as is known in the art, including standard computing components such as network and media interfaces, computer-readable storage (memory), and processors for executing instructions that may be stored in memory.

Server 102 may be linked to a video clip library containing various video clips. Server 102 may also provide a mechanism for users, including a casting call manager, to view, select, upload, and/or otherwise obtain one or more video clips for use in generating a casting call. In some embodiments, a video clip may require payment of a fee, which may also be process by server 102 or by an auxiliary device in communication with server 102. Additionally, the user may be provided a mechanism for rehearsing with the selected video clip prior to recording the user in a portion of the video clip. Once the user portion is recorded, the server 102 may produce the composite video clip by merging or compositing a recording of the user into the video clip.

In an alternative embodiment, some of the functionalities of the server 102 (e.g., for generating a modified video clip) may be provided to a user device 106A, for example, via a downloadable application or applet. An applet may be downloaded from the server 102 to the user device 106A over communication network 104. Such an applet may allow a user to play a selected video clip on a computing device associated with the user, as well as record the user performance to be merged or composited into the selected video clip. In some embodiments, the applet may also include security measures to limit the play of the video clip to the computing device(s) associated with the user.

The user devices 106A-106B may be associated with one or more users interested in generating a composite video clip. The user devices 106A-106B may include any type of device that has access to the communication network 104. User devices 106A-106B may be any computing device as is known in the art, including standard computing components such as network and media interfaces, computer-readable storage (memory), and processors for executing instructions that may be stored in memory. User devices 106A-106B may comprise, for example, a computing device, laptop or desktop computer, cellular telephone, personal digital assistant (PDA), MP3 player, or any other computing or digital device.

It should be noted that FIG. 1 illustrates one exemplary embodiment of the environment 100. Alternative embodiments may comprise any number of user devices 106A-106B coupled to any type of communications network 104. Additionally, more than one server 102 may be present. For example, back-up or redundancy servers, or servers tasked with particular responsibilities, including but not limited to Digital Rights Management (DRM), advertising or payment processing, may also be present.

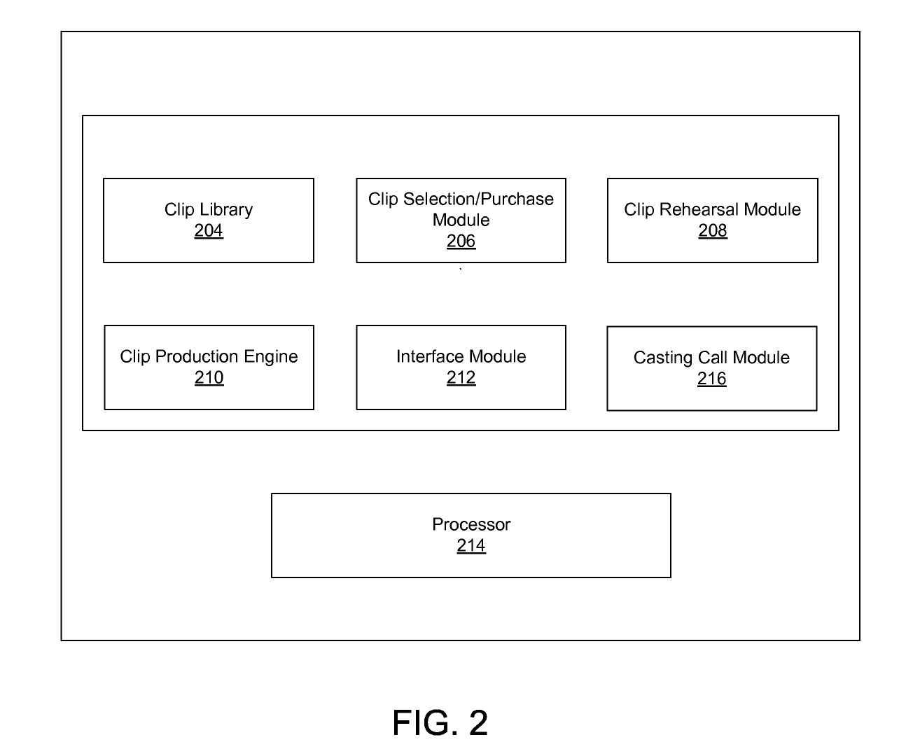

FIG. 2 illustrates an exemplary server 102 for generating a composite video clip. Server 102 may comprise a memory 202, which may include a clip library 204, clip selection/purchase module 206, clip rehearsal module 208, clip production engine 210, an interface module 212, and casting call module 216. The clip selection/purchase module 206, clip rehearsal module 208, clip production engine 210, interface module 212, and casting call module 216 may be executable by a processor 214.

Memory 202 is any memory configured to store data. Some examples of the memory 202 are storage devices, such as RAM or ROM. Memory 202 may store various databases, including a clip library 204, and may be housed with the server 102 or in a separate device.

Clip library 204 is a database for storing various media clips. The media clips may include audio and video clips. Such media clips may be provided from various sources, including authors/creators of such media clips, users of the system, partners, associates, etc. In some embodiments, the clip library 204 may be indexed according to type of clip, type of performance, size, content, and various categories.

Clip selection/purchase module 206 may be executable to handle transactions regarding selection and transfer of a video clip to a user. A module (or application), as referenced in the present invention, should be generally understood as a collection of routines that perform various system-level functions and may be dynamically loaded and unloaded by hardware and device drivers as required. The modular software components described herein may also be incorporated as part of a larger software platform or integrated as part of an application specific component.

In particular, clip selection/purchase module 206 may allow for browsing and/or selection from a menu based on the clips available in clip library 204. Samples of the script or of the actual video clips may be provided for confirmation regarding the content of the video clip. The user may then select a video clip from the menu. Alternatively, the user may search for a particular video or particular type of video. For example, a casting call may request or refer to a particular video clip or type of video clip to express the need for a particular type of performance. The user may search for the video clip by an identifier or using various other search parameters. In some implementations, a fee may be required to access and play certain video clips. Clip selection/purchase module 206 may further be configured to securely process such transactions.

Once the user selects (and, if required, pays for) a video clip, the user is allowed access to the video clip. In one embodiment, the video clip remains stored at server 102 and accessed via a media player on the internet. Clip rehearsal module 208 allows for a user to play the video clip for rehearsal purposes. Toward this end, the clip rehearsal module 208 may present the video clip with a script in the form of subtitles or captions. The user may therefore play the video clip and perform the lines along with the performance in the video clip. In some embodiments, the video clip may be downloaded to a user device. Clip rehearsal module 208 may process the video clip to include subtitles/captions or provide an applet that inserts the subtitles/captions.

Clip production engine 210 merges a user recording with the selected video clip, such that a user performance replaces a recorded performance in the context of the video clip. For example, a video clip of a stage performance of Romeo and Juliet may be composited with a recording of a user who wishes to perform the part of Romeo. As such, the Romeo of the original media clip may be replaced, in part or wholly, by the user. Compositing may include using various techniques, such as facial recognition, automatic scaling, pixel blending, and/or any other equivalent processes to create the composited video clip. The compilation, for example, may comprise detecting the location of a user's eyes, noise, and mouth. A portion of the recorded image (e.g., of the face of the user) of the recording is then composited into the editable version frame by frame (e.g., the recorded image of the user's face is merged over a face on the original video clip) to generate a composited video clip. Some aspects of compositing may be done automatically, and some aspects may be done based on user input.

Server 102 further comprises interface module 212 configured to send and receive information, such as video clips, pre-engineered video clips, composited recordings, messages, alerts, e-mails, casting calls, to and/or from a user of the interactive entertainment system. For example, interface module 212 may receive a user selection of a video clip from the clip library, send a user a pre-engineered version of the video clip designated by the user selection, and receive a recording of a user performance associated with a selected video clip. Interface module 212 may also operate in conjunction with other modules to process transactions, provide access to media clips, and allow for user editing of the composite video clip.

Casting call module 216 may be used to generate a casting call for a performer. An individual may use casting call module 216 to create a casting call for posting or linking on a website. Such an individual may select or upload a video clip, indicate a role of a performer in the video clip, and provide further information, such as contact information for any submissions. The information is stored and managed by casting call module 216. In some embodiments, a casting call may be associated with an identifier for querying. Alternatively, the selected video clip may be associated with an identifier. When a user submits a query to participate in the casting call, the user may be provided with the information associated with the casting call. For example, the user may be provided with the contact information for a recipient designated to receive casting call submissions.

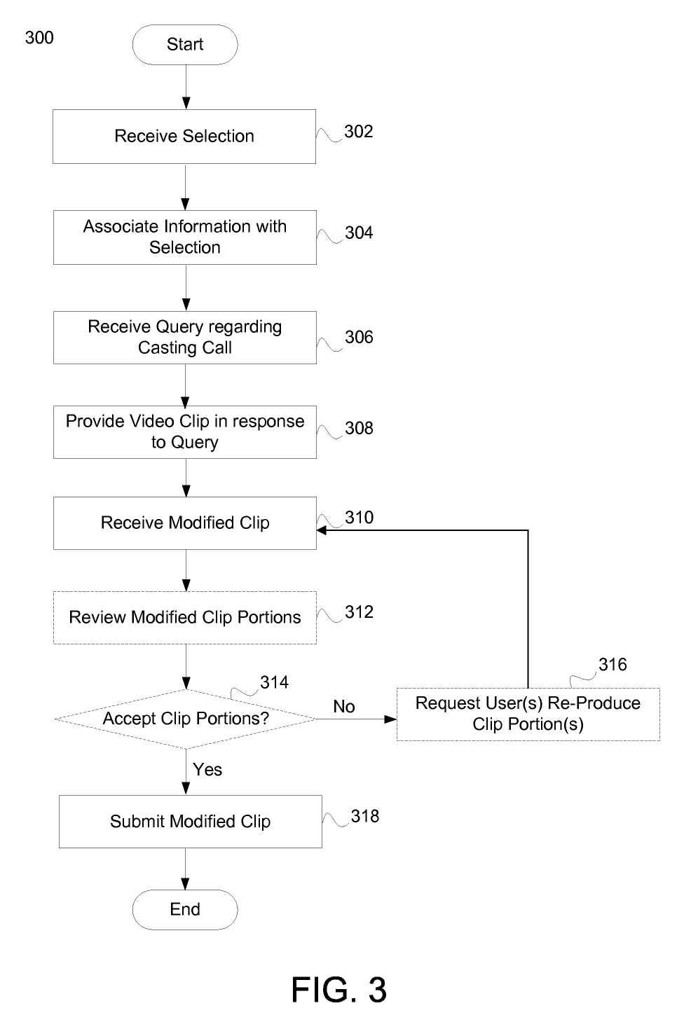

FIG. 3 is a flowchart of an exemplary method for casting calls. In the method, a casting call is generated and stored in memory. A query may be received from a user, who may then be provided with access to the video clip associated with the casting call. The user modifies the video clip to incorporate a recording of a performance. The modified video clip may then be submitted to the casting call. In some embodiments, the modified video clip is evaluated for compliance to any parameters associated with the casting call, and the user may be notified as to whether compliance is met. If compliance is found, then the modified video may then be submitted to the designated recipient associated with the casting call.

In step 302, a casting call is generated. In exemplary embodiments, an individual may, using a user device 106A, access the server 102, review the clip library, and select one of the video clips. Specifically, casting call generator 216 generates the casting call, which may be posted for various “roles” in the selected video clip. For example, the video clip may comprise three roles (i.e., performers/characters) which may be performed by users of the interactive entertainment system. The individual creating the casting call may be a casting call manager who wishes to cast the three roles, or the individual may be a user acting one of the roles and looking for other users to perform the other two roles. As such, a casting call may identify the video clip, the available role(s), and provide contact information. The casting call may further be posted to a website associated with the server 102.

In step 304, the information provided by the creator of the casting call is stored in memory as being associated with the casting call. Identifiers and indexing may be involved, in order to allow for various types of searches and queries. In some embodiments, the actual contact information is not provided to users. Instead, a user makes the submission to the casting call module 216, which then forwards the submission to the designated recipient (after an optional evaluation for compliance with any parameters).

Various other users may review these casting calls and submit queries regarding casting calls of interest. In step 306, a user submits a query regarding a particular casting call. The query may be received via e-mail or be accessed via the server 102. The query may specify the particular casting call or the video clip associated with the casting call.

In step 308, the user may be provided with the specified video clip portions to the hired users. In some embodiments, the video clip provided to the user is associated with a DRM key only useable by the user or user device. Each user participating in the casting call may receive a different version/portion of the video clip and different DRM keys. In one embodiment, the video clip portion may be a portion of a scripted (e.g., karaoke) video clip which includes lines of a script displayed for the hired user to read. The user may then record a performance and submit the recording for incorporation into the video clip. The user may be offered various tools for editing the video clip, including adjusting color, brightness, etc. Such post-production activity may occur at the server 102.

In step 310, the modified video clip may then be submitted. In some embodiments, the submission may go directly to the designated recipient associated with the casting call. Alternatively, the submission may be submitted for review by casting call module 216 to determine compliance with one or more parameters associated with the casting call.

In step 312, the modified video clip submitted by the user in step 310 is evaluated based on any parameters indicated by the casting call. For example, a creator of the casting call may indicate certain size restrictions, length restrictions, quality requirements, etc. Such parameters are applied to the modified video clip submitted by the user.

In step 314, the determination is made as to whether to accept the modified video clip recording submitted in step 310. If the modified video clip doe not comply with the parameters of the casting call, the user may be notified that the modified video clip is not accepted and therefore, will not be forwarded to the designated recipient of the casting call submission. The user may also be notified if the modified video clip does meet the parameters of the casting call and will be forwarded to the designated recipient.

If the modified video clip does not meet the parameters of the casting call, the user may be provided with an explanation and be allowed to submit another modified video clip in step 316. If the user does take advantage of this opportunity, the method returns to step 310 with respect to submission of the new modified video clip.

In step 318, the modified (and compliant) video clip is submitted to the designated recipient of submissions for the casting call. As noted above, the submission may occur by providing the user with the recipient contact information or by providing tools of submission. For example, a form may allow for the user to upload the modified video clip and designate the submission for a particular casting call. Casting call module 216 may determine the recipient associated with the casting call, retrieve the contact information, and address the submission accordingly.

It should be noted that the method of FIG. 3 is exemplary. Alternative embodiments may comprise more, less, or other steps and still be within the scope of the present embodiment. Additionally steps may be practiced in a different order.

The present invention may be implemented in an application that may be operable using a variety of end user devices. The present methodologies described herein are fully intended to be operable on a variety of devices. The present invention may also be implemented with cross-title neutrality wherein an embodiment of the present system may be utilized across a variety of titles from various publishers.

Computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method for casting calls, the method comprising:
maintaining a clip library in memory, the clip library comprising a plurality of video clips;
receiving a query from a user, the query requesting a video clip designated by for use in the casting call;
providing the user with access to the requested video clip for modification by way of incorporation of a recording of a performance, the recording designated by the user;
receiving the modified video clip from the user; and
submitting the modified video clip to a recipient designated by the user, the recipient being associated with the casting call.

2. The method of claim 1, wherein the recipient is a casting call manager.

3. The method of claim 2, further comprising generating the casting call based on information provided by the casting call manager.

4. The method of claim 3, wherein generating the casting call comprises:
receiving a selection from the casting call manager, the selection designating the video clip for use in the casting call; and
associating the casting call with contact information provided by the casting call manager, wherein the modified video clip is submitted using the contact information provided by the casting call manager.

5. The method of claim 1, further reviewing the received and modified video clip in accordance with a parameter associated the casting call.

6. The method of claim 5, further comprising generating a notification to the user, the notification concerning whether the received and modified video clip corresponds with the parameter associated with the casting call.

7. The method of claim 1, wherein the recipient is a database accessible to another user via a communication network.

8. The method of claim 7, further comprising hosting the database, wherein the other user has access to the requested video clip for modification by way of incorporation of another recording of another performance, the other recording designated by the other user.

9. The method of claim 1, further comprising determining that the modified video clip is a duplicate of another video clip and generating a notification to the user.

10. A system for casting calls, the system comprising a memory configured to store a clip library comprising a plurality of video clips;
an interface configured to:
receiving a query from a user, the query requesting a video clip designated by for use in the casting call,
providing the user with access to the requested video clip for modification by way of incorporation of a recording of a performance, the recording designated by the user,
receiving the modified video clip from the user, and
submitting the modified video clip to a recipient designated by the user, the recipient being associated with the casting call.

11. The system of claim 10, further comprising a casting call module stored in memory and executable by a processor to generate a casting call

12. The system of claim 11, wherein the casting call module is executable to generate the casting call by:
receiving a selection from the casting call manager, the selection designating the video clip for use in the casting call; and
associating the casting call with contact information provided by the casting call manager, wherein the modified video clip is submitted using the contact information provided by the casting call manager.

13. The system of claim 10, wherein the casting call module is further executable to review the received and modified video clip in accordance with a parameter associated the casting call.

14. The system of claim 13, wherein the casting call module is further executable to generate a notification to the user, the notification concerning whether the received and modified video clip corresponds with the parameter associated with the casting call.

15. A computer-readable storage medium, having embodied thereon a program, the program being executable by a processor to perform a method for casting calls, the method comprising:
maintaining a clip library in memory, the clip library comprising a plurality of video clips;
receiving a query from a user, the query requesting a video clip designated by for use in the casting call;
providing the user with access to the requested video clip for modification by way of incorporation of a recording of a performance, the recording designated by the second user;
receiving the modified video clip from the user; and
submitting the modified video clip to a recipient designated by the user, the recipient being associated with the casting call.

16. The computer-readable storage medium of claim 15, wherein the program is further executable to generate the casting call based on information provided by a casting call manager.

17. The computer-readable storage medium of claim 16, wherein generating the casting call comprises:
receiving a selection from the casting call manager, the selection designating the video clip for use in the casting call; and
associating the casting call with contact information provided by the casting call manager, wherein the modified video clip is submitted using the contact information provided by the casting call manager.

18. The computer-readable storage medium of claim 15, wherein the program is further executable to review the received and modified video clip in accordance with a parameter associated the casting call.

19. The computer-readable storage medium of claim 18, wherein the program is further executable to generate a notification to the user, the notification concerning whether the received and modified video clip corresponds with the parameter associated with the casting call.

20. The computer-readable storage medium of claim 15, wherein the recipient is a database accessible by another user, wherein the other user has access to the requested video clip for modification by way of incorporation of another recording of another performance, the other recording designated by the other user.
